(19) United States
(12) Patent Application Publication
(10) Pub. No.: US 2008/0222023 A1
(43) Pub. Date: Sep. 11, 2008

(54) Internet-Based System for Auctioning Securities

(75) Inventors: William R. Hambrecht, San Francisco, CA (US); Whitney White, New York, NY (US); Edward John Schneider, San Francisco, CA (US); Harrison Clay, San Francisco, CA (US); Alan Katz, Dallas, TX (US); Thomas Peterffy, Greenwich, CT (US)

Correspondence Address: BROMBERG & SUNSTEIN LLP, 125 SUMMER STREET, BOSTON, MA, 02110-1618, US

(73) Assignee: W.R. HAMBRECHT + CO., LLC, San Francisco, CA (US)

(21) Appl. No.: 12/108,820

(22) Filed: Apr. 24, 2008

Related U.S. Application Data
(63) Continuation-in-part of application No. 11/447,602, filed on Jun. 6, 2006.
Application No. 11/447,602 is a continuation-in-part of application No. 10/226,243, filed on Aug. 23, 2002.
Application No. 10/226,243 is a continuation-in-part of application No. 10/020,216, filed on Dec. 18, 2001, now abandoned.
(60) Provisional application No. 60/286,965, filed on Apr. 30, 2001.

(51) Int. Cl. G06Q 30/00

(52) U.S. Cl. 705/37

(57) ABSTRACT

A method of auctioning exchange traded assets is described. Before commencing the auction bidding, the seller establishes a maximum asset amount representing a greatest amount of the exchange traded assets to be auctioned, and a minimum asset price representing a minimum acceptable bid amount for a given amount of the exchange traded assets. During the bidding, bids are received for the assets, with each bid including a bid price and a corresponding bid amount of assets. After the bidding, a market demand is determined that represents the total of all the bid amounts for the bids. If the market demand is greater than or equal to the maximum asset amount, a clearing price is established that allocates the maximum asset amount of the assets according to the bids at a final price between and including the clearing price and the minimum asset price. Otherwise, if the market demand is less than the maximum asset amount, the market demand amount of the assets according to the bids at a final price equal to the minimum asset price.

### CROSS-REFERENCE TO RELATED APPLICATIONS

This application is a continuation in part of U.S. patent application Ser. No. 11/447,602, filed Jun. 6, 2006, which is a continuation-in-part or U.S. patent application Ser. No. 10/226,243, filed Aug. 23, 2002, which is a continuation of U.S. patent application Ser. No. 10/020,216, filed Dec. 18, 2001, which claimed priority from U.S. Provisional Application No. 60/286,965, filed Apr. 30, 2001 and titled “Internet-Based System for Auctioning Follow-on Offerings of Securities.” All of the above listed applications are hereby incorporated by reference.

### FIELD OF THE INVENTION

The present invention relates to the field of Internet computer systems for securities auctions.

### BACKGROUND ART

A company that has become publicly traded through an initial public offering may raise additional capital through a follow-on offering of securities. In a follow-on offering, the publicly-traded company sells additional equity securities (e.g., shares of common stock) to the public. Typically, these securities are offered to institutional investors at a price discounted from the closing price of the company's stock on the day that the follow-on offering occurs.

An increasing number of follow-on and secondary offerings are done via overnight transaction, whereby the underwriter steps in and buys the entire offering and takes on the risk of finding secondary buyers for the offered shares. The obvious benefit of this approach to the issuer or selling shareholders is that they bear no risk of a broken transaction. The disadvantage to the issuer/selling shareholder is that their cost of capital for obtaining a guaranteed transaction may be higher than their costs for doing a direct-to-market transaction, though both bought and non-bought deals are typically done at a discount to the last quoted market price.

Bought deals are typically only done for the most liquid stocks, since the distribution risks for the underwriter are inversely related to the liquidity. To take the additional underwriting risk associated with a bought deal, the underwriter must determine a price discount that sufficiently compensates for the additional risk. The greater the quantity of stock that the underwriter can lay off to interested buyers simultaneously with the transaction, the smaller the risk assumed by the underwriter. Moreover, the underwriter can engage in derivative transactions to insure against unfavorable market movements in the stock, but these transactions come at a cost that must be comprehended in the discount.

### SUMMARY OF THE INVENTION

Embodiments of the present invention are directed to auctioning exchange traded assets such as securities or commodities. Before commencing the auction bidding, the seller establishes a maximum asset amount representing a greatest amount of the exchange traded assets to be auctioned, and a minimum asset price representing a minimum acceptable bid amount for a given amount of the exchange traded assets. During the bidding, bids are received for the assets, with each bid including a bid price and a corresponding bid amount of assets. After the bidding, a market demand is determined that represents the total of all the bid amounts for the bids. If the market demand is greater than or equal to the maximum asset amount, a clearing price is established that allocates the maximum asset amount of the assets according to the bids at a final price between and including the clearing price and the minimum asset price. Otherwise, if the market demand is less than the maximum asset amount, the market demand amount of the assets according to the bids at a final price equal to the minimum asset price.

### BRIEF DESCRIPTION OF THE DRAWINGS

FIG. 1 is a block diagram of an Internet-based system for auctioning follow-on offerings of securities.

FIG. 2 is a flow chart of an auction process using the system of FIG. 1.

FIG. 3 is a flow chart of a procedure for conducting an auction as part of the process of FIG. 2.

FIG. 4 is a flow chart of a procedure for receiving bid information.

FIG. 5 is a flow chart of a procedure for processing a live bid as part of the process of FIG. 4.

FIG. 6 is a flow chart of a procedure for processing a limit bid as part of the process of FIG. 4.

FIG. 7 is a flow chart of a procedure for editing or canceling bids as part of the process of FIG. 3.

FIG. 8 is a flow chart of a procedure for processing bids as part of the process of FIG. 3.

FIG. 9 is a flow chart of a procedure for allocating shares as part of the process of FIG. 3.

FIGS. 10-20 are screen shots of an auction conducted according to the procedure of FIG. 3 using the system of FIG. 1.

FIG. 21 is a flow chart of another procedure for conducting an auction as part of the process of FIG. 2.

FIG. 22 is a flow chart of a procedure for processing bids as part of the process of FIG. 21.

FIGS. 23 and 24 are flow charts of procedures for allocating shares as part of the process of FIG. 21.

FIG. 25 is a flow chart of an offering allocation procedure in another embodiment of the present invention.

Like reference symbols in the various drawings indicate like elements.

### DETAILED DESCRIPTION OF SPECIFIC EMBODIMENTS

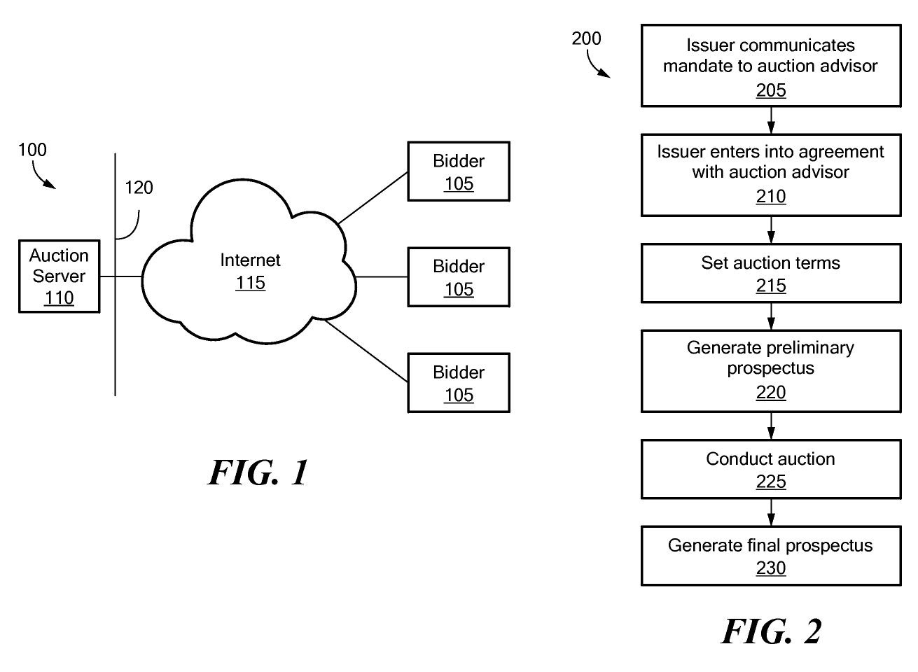

Referring to FIG. 1, an internet-based system 100 for auctioning follow-on offerings of securities permits bidders 105 to bid for the securities in a follow-on offering by connecting to an auction server 110 through the Internet 115. The auction server 110 is a computer that implements an automated, real-time auction of a follow-on offering of securities. Each bidder 105 uses an electronic device, such as a personal computer, a personal digital assistant, or a mobile telephone, to participate in the auction through a wired or wireless Internet connection to the auction server 110.

In one implementation, the auction server 110 presents the auction as a publicly-accessible web page that is accessed by the bidders using standard Web browsing software. In other implementations, the auction may be presented through a connection to proprietary or other software being run by the bidders. The auction server 110 collects and stores all bids submitted pursuant to the auction. A firewall 120 provides security between the Internet 115 and the auction server 110.

Referring to FIG. 2, an auction is initiated and conducted according to a procedure 200. Initially, the issuer of the securities communicates its mandate to the auction advisor who runs the auction server 110 (step 205). The auction advisor also may be an underwriter for the auction. The mandate indicates that the issuer wants to conduct an offering using the auction server 110. Next, the issuer and the auction advisor enter into an auction agreement (step 210). The auction agreement sets forth the terms and conditions of the auction advisor's role. For example, one such term and condition may be the issuer's agreement to indemnify the auction advisor against liability. Once an agreement is reached, the auction terms are set (step 215). Terms of the auction may include, for example, the opening price, the number of shares offered, the terms of any warrants offered, the price increment for rounds of the auction after the initial round, the date and starting time for the auction, the time increment for each round, the minimum shares per bid, the maximum shares per bid, and the maximum clearing price.

The opening price is set at a value selected by the issuer and the underwriters. Typically, the opening price is set to be no more than ten percent below the closing price of the security on the day of the auction. The terms of the warrants include the number of shares associated with each warrant, the exercise price per warrant, any warrant redemption provisions, and the warrant expiration date. Default values for the time increment for each round are five to ten minutes for the initial round and two minutes for each subsequent round. Typically, the issuer files a registration statement that details the auction terms.

After the registration statement is filed, a preliminary prospectus is made available to the bidders on the auction advisor's website 10 (step 220). The preliminary prospectus reports the auction terms and the rules that will govern the auction, including a plan of distribution. In general, shares offered by the preliminary prospectus may not be sold prior to the time that the registration statement is declared effective by the appropriate regulatory body.

The preliminary prospectus also may report, as a part of the plan of distribution, on the various agreements entered into by the issuer and underwriters. For example, the issuer may grant the underwriters an option, exercisable after a certain period of time after the conclusion of the auction, to purchase a certain number of additional shares at the offering price, less the underwriting discount, in order to cover over-allotments. The shares subject to each underwriter's over-allotment option are used to calculate the clearing price whether or not the option is actually exercised.

Pursuant to the plan of distribution, the issuer also may grant the underwriters the right to reserve a portion of the offered shares for sale to certain individuals or entities. These reserved shares will reduce the overall number of shares offered in the auction and will not be subject to the terms of the auction. The underwriters may additionally reserve the right to round allocations in order to eliminate odd-lots—e.g., to the nearest 100 shares, to engage in transactions that have the effect of stabilizing or maintaining the market price of the shares, and to engage in passive market making transactions. Also in the plan of distribution, the issuer, and its directors and officers, may agree not to offer, sell, contract to sell, or otherwise dispose of shares of the offered securities for a defined period after the date of the auction.

Once the registration statement has been declared effective, the auction may begin. At this time, the underwriters and participating dealers may contact potential bidders with information about the auction and how to participate. Typically, a participant must be a customer of one of the underwriters or the participating dealers. Next, the auction is conducted (step 225). The auction is held shortly after the close of the trading day of the principal market for the offered shares. Additionally, underwriters may reserve the right to reject bids that they deem manipulative or disruptive in order to facilitate the completion of the offering, and they may reserve the right, in exceptional circumstances, to alter the method of allocation as they deem necessary to ensure a fair and orderly distribution of the offered shares. For example, a large bid may be reduced in order to ensure a public distribution. When the auction is complete, a final prospectus is made available to the bidders at the auction server (step 230). The final prospectus contains a disclosure of the results of the auction as well as screen shots of each round of the auction.

The sale price is ultimately determined by negotiation between the underwriters and the issuer after the auction closes. The sale price may be below, but will not be above, the clearing price set by the auction. The auction server, participating dealers, or underwriters notify successful bidders (typically by e-mail, but alternatively by telephone, mail or facsimile) that the auction has closed and their bids have been accepted. Unsuccessful bidders are notified that their bids have not been accepted. Bidders may, at any time, request that all, or any specific, communications between them and the auction server, the underwriters, or the participating dealers be made by a specific means of communication, including e-mail, telephone, or facsimile.

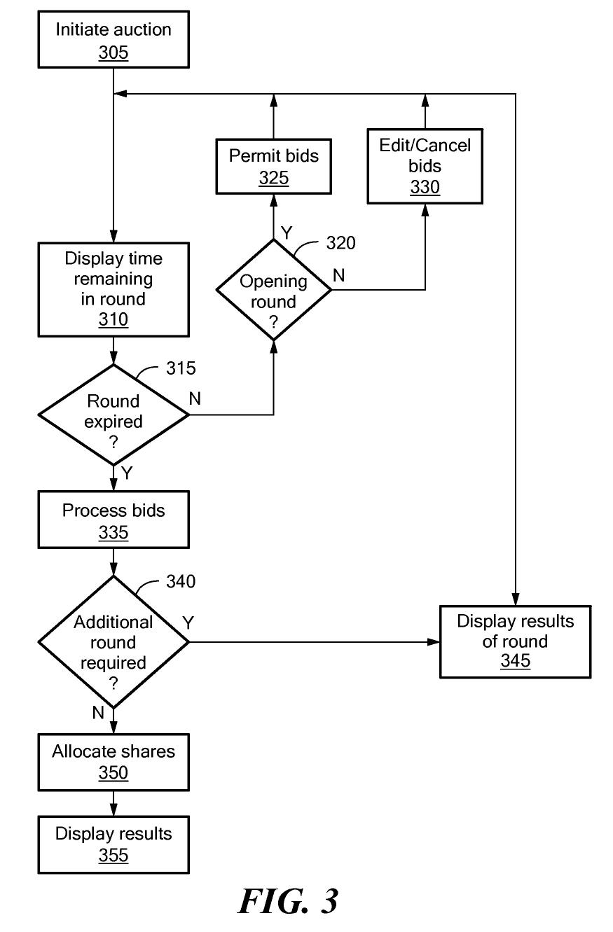

Referring to FIG. 3, an auction is conducted according to a procedure 225. After the auction is initiated (step 305), the time remaining in the auction round is displayed (step 310). A participant then is permitted to enter bids until the initial round expires, and to edit or cancel bids in subsequent rounds. In particular, after the time remaining has been displayed, a check is made as to whether the round has expired (step 315) and, if not, a check is made as to whether the auction is in the opening round (step 320). In the opening round, entry of bids is permitted (step 325). In subsequent rounds, editing or canceling of bids is permitted (step 330). Thereafter, the displayed time remaining in the round is updated (step 310) and the process repeats until the round expires (step 315). In one implementation, the opening round is 10 minutes long and subsequent rounds are 2 minutes long. Each auction may include multiple rounds.

During each round of the auction, a participant places bids for a desired number of shares. In general, a maximum bid size is defined as a percentage of the total offering and may be up to 100%. If equity warrants are included with the offering, a participant bids for a desired number of units. Units include shares of stock and a predetermined percentage of warrants. Warrant terms are fixed prior to the auction's start.

In the implementation illustrated in FIG. 3, a participant must place a bid in the opening round to be included in the auction. However, other implementations may allow a participant to join active auctions based on specific criteria such as auction size, bidding pressure, and security offeror's interest. Bids may be restricted based upon credit limits. The initial bid price is set at the starting price determined by the issuing company. A participant may place live or limit bids. Multiple bids are allowed.

Bids are processed at the conclusion of each round (step 335). All bids that have not been withdrawn are considered. The auction continues through successive rounds until a round closes with the auction undersubscribed. An auction is undersubscribed when the demand for the securities does not exceed the amount of securities being offered. If the auction is not undersubscribed, then an additional round is required (step 340), and the cumulative demand and round results are displayed (step 345). If an additional round is not required (step 340), the shares are allocated (step 350), with the clearing price corresponding to the highest price that at least fully subscribes the auction.

After the shares are allocated, results are displayed (step 355). The display may include the final clearing price and the number of shares. Results also may be communicated directly to successful participants. In one implementation, a successful participant receives e-mail notification of the share allocation.

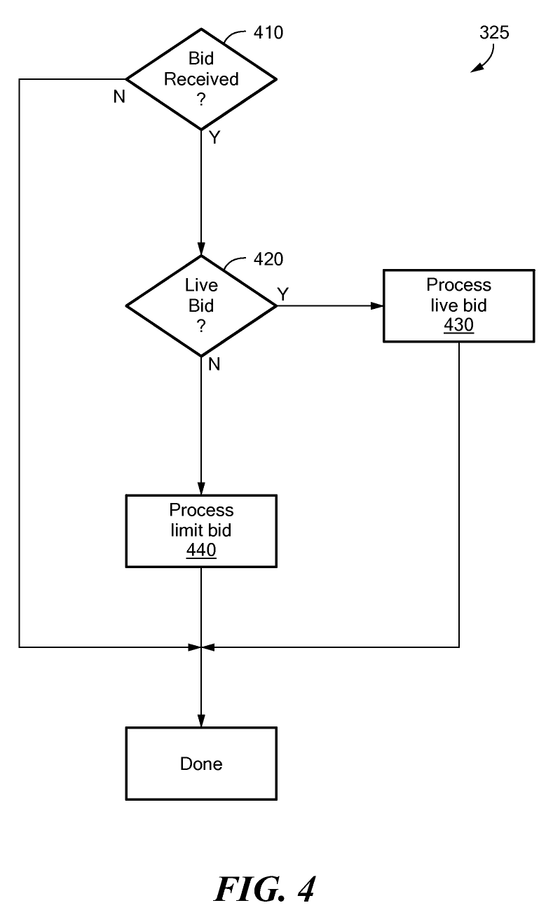

Referring to FIG. 4, a participant is permitted to enter bids according to a procedure 325. In one implementation, bids may be initiated only during the initial round of the auction. When a bid is received (step 410), a determination is made as to whether the bid is a live bid (step 420). If so, the bid is processed as a live bid (step 430). Otherwise, the bid is processed as a limit bid (step 440). A participant is allowed to place multiple live and limit bids. Since each bid is independent, combinations of live and limit bids are allowed.

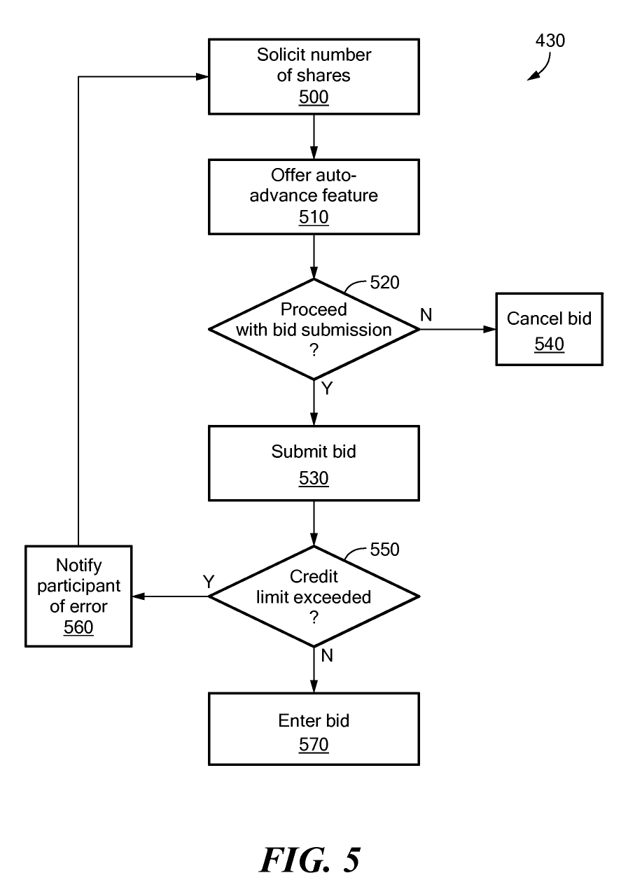

Referring to FIG. 5, live bids are processed according to a procedure 430. Initially, a participant is presented with a dialog to enter live bid information. To place a live bid, the participant specifies only the desired number of shares (step 500). This selection represents the maximum size of the bid, as subsequent edits will only allow the participant to reduce the bid size.

Next, the participant is offered an opportunity to select the auto-advance feature (step 510). The auto-advance feature allows the bid to be automatically increased by a pre-announced auction-specific price increment following each auction round. If the auto advance feature is not chosen, the participant is given the opportunity to advance the bid to the new price prior to the close of each round. To advance the bid, the participant must manually increase the bid to match the current offer price before the conclusion of each auction round to keep the bid active for the next round in the auction.

After the bid information has been entered, the participant is prompted as to whether to proceed with submitting the bid (step 520), and the participant may choose whether to submit the bid (step 530) or cancel the bid (step 540). In one implementation, a canceled bid cannot later be revived. However, in other implementations, the participant may be able to save the bid as a draft bid. The draft bid may be finalized and submitted later during the same round or a subsequent round, when permitted. This feature gives the participant an opportunity to observe auction dynamics and rapidly enter an earlier modified bid without redundant entry of bid information.

If the bid is submitted (step 530), the participant's credit limit is analyzed to ensure that the bid does not commit funds in excess of an approved limit (step 550). If the participant's credit limit is exceeded, the participant is notified and prompted to adjust the bid information (step 560). If the credit limit has not been exceeded, the bid is entered into the auction (step 570).

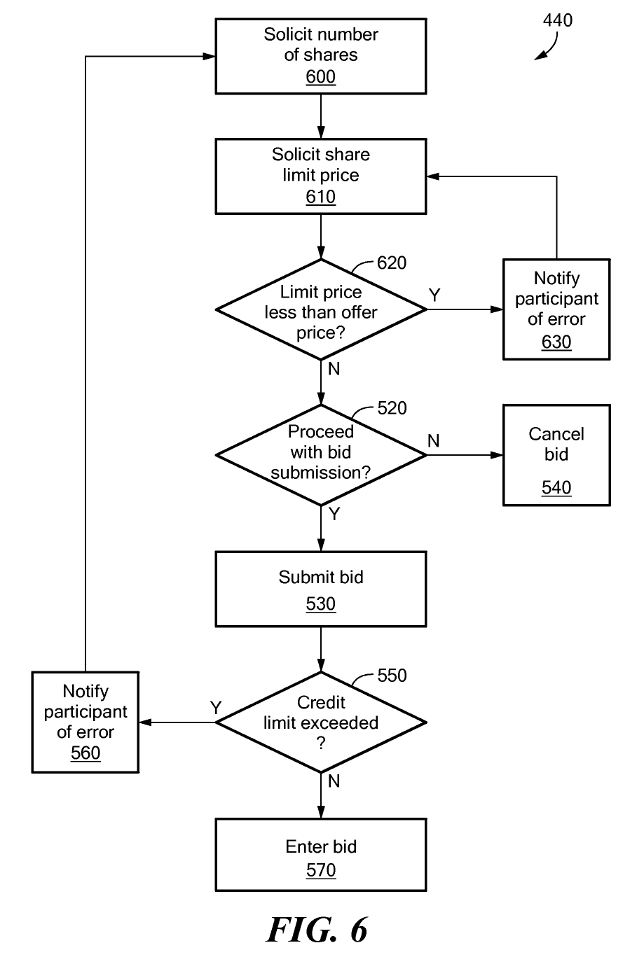

Referring to FIG. 6, limit bids are processed according to a procedure 440 that is similar to the procedure 430 for processing live bids. Initially, the participant is presented with a dialog to enter limit bid information. To enter a limit bid, the participant must specify the number of shares for the bid (step 600). This selection represents the maximum size of the bid, as subsequent edits will only allow the participant to reduce the bid size. The participant also must enter a maximum limit purchase price for the shares (step 610). A check is then made as to whether the limit price is greater than or equal to the auction's offering price (step 620). If the limit price is not greater than or equal to the offering price, which is a requirement for a limit bid, then the participant is notified and prompted to enter a new limit price (step 630).

If the limit price is greater than or equal to the offering price, then the procedure proceeds with bid submission and credit checking according to steps 520-570 as discussed above with respect to procedure 430.

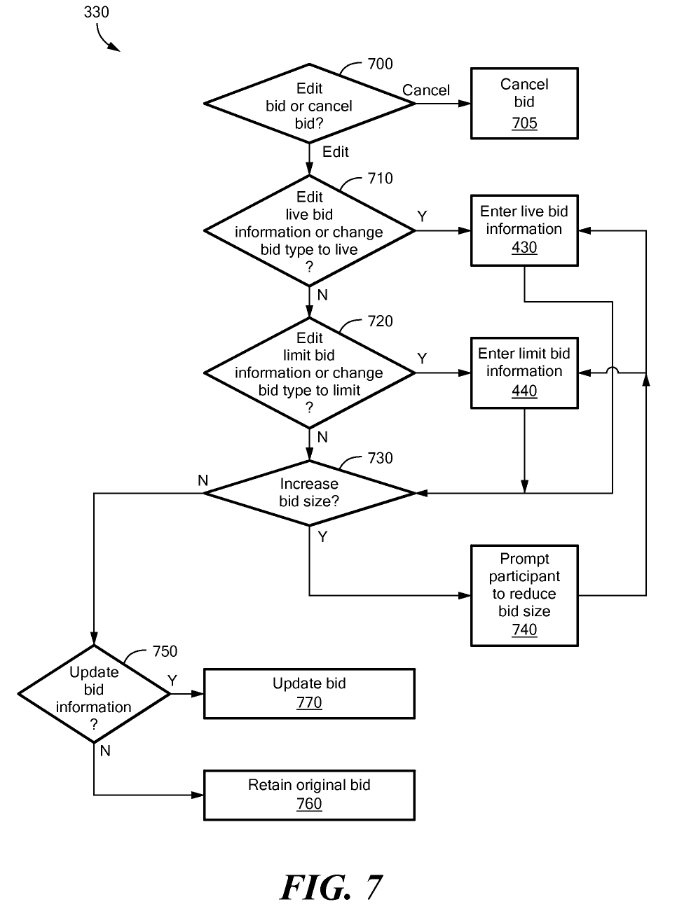

Referring to FIG. 7, auction bids may be edited or cancelled according to a procedure 330, but the edit or cancellation is only effective for rounds that have not yet closed. Bids are edited or cancelled independently of each other. If a user cancels a bid (step 700), the cancelled bid is removed from the current round (step 705). In one implementation, a cancelled bid can never be reinstated.

When editing a bid, the participant may edit the bid type or edit the bid information. If a limit bid is changed to a live bid type or if a live bid is edited (step 710), the participant has the opportunity to enter live bid information according to the procedure 430 discussed above. As noted above, the participant may modify the number of shares (step 500) and select the auto-advance feature (step 510). By toggling the auto-advance feature for live bids, a participant may use the auto-advance feature for the entire auction or during specific periods of the auction.

If a live bid is changed to a limit bid, or if limit bid information is edited (step 720), the participant has the opportunity to enter limit bid information according to the procedure 440 discussed above. As discussed above, the participant may edit the number of shares (step 600) and the maximum share price for the bid (step 610). The maximum share price must be greater than or equal to the current offering price.

If a bid is modified, the number of shares of the modified bid can be decreased in size for each new round but cannot be increased. Accordingly, the bid size is reviewed to see if the number of shares has increased (step 730) and, if so, the participant is prompted to reduce the bid size (step 740).

When all bid information has been entered, and the bid size has not been increased (step 730), the participant may chose whether to submit the bid modifications (step 750). If the bid modifications are not submitted, the original bid information is retained (step 760). If the bid modifications are submitted, the new bid information replaces the original bid information (step 770). One implementation may allow participants to copy existing bids so that both the original bid and the new bid are retained. Using this process, a participant under time constraint can quickly enter several bids. Additionally, this copy feature reduces redundant entry for bids that contain similar information.

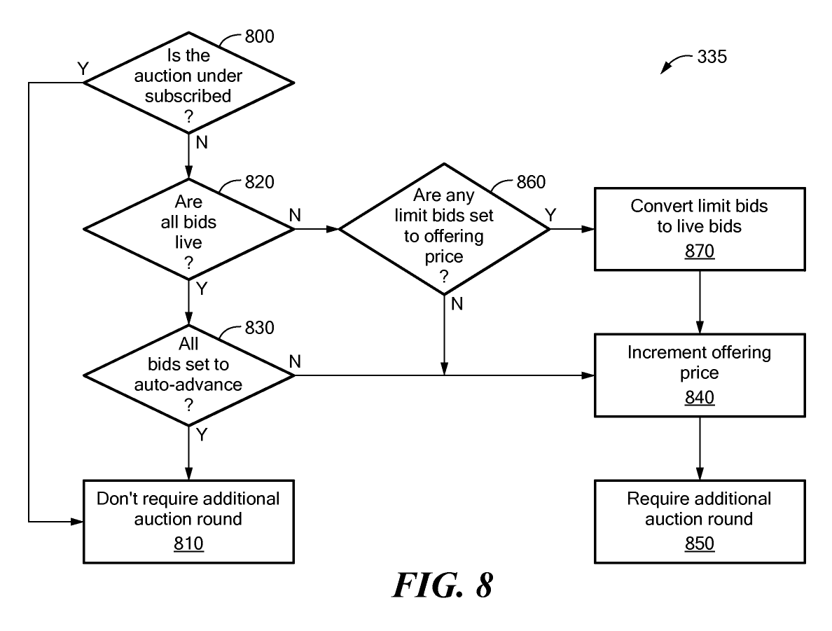

Referring to FIG. 8, once the auction's current round has completed, bids are processed according to a procedure 335. First, a determination is made as to whether the auction is undersubscribed (step 800). If the auction is undersubscribed, no additional are rounds required (step 810). In one implementation (not shown), the issuing company may restart the auction at a lower price when the offering is undersubscribed at the opening price. In this implementation, all outstanding bids are cancelled, and participants are prompted to bid again.

If the auction is not undersubscribed (step 800), the bid types are reviewed. If all bids are live (step 820) and set to auto-advance (step 830), the auction ends and no additional auction rounds are required (step 810). If all of the bids are live and at least some of the bids are not set to auto-advance (step 830), then the offering price is increased by a pre-announced auction-specific price increment (step 840) and another auction round is required (step 850).

If the auction contains any limit bids (step 850), the bid price of each limit bid is reviewed. If a limit bid price matches the offering price (step 860), the limit bid is converted to a live bid for the next auction round (step 870). Any limit bids with prices above the offering price are unaffected. Next, the offering price is increased by a pre-announced auction-specific price increment (step 840) and another auction round is required (step 850).

In another implementation, which is not shown, auctions also may end if the offering price ascends to and is oversubscribed at a price that is a certain level (e.g. 10%) over the day's closing price on the issuing company's principal market. In this situation, each remaining bidder receives a pro rata allocation at that price.

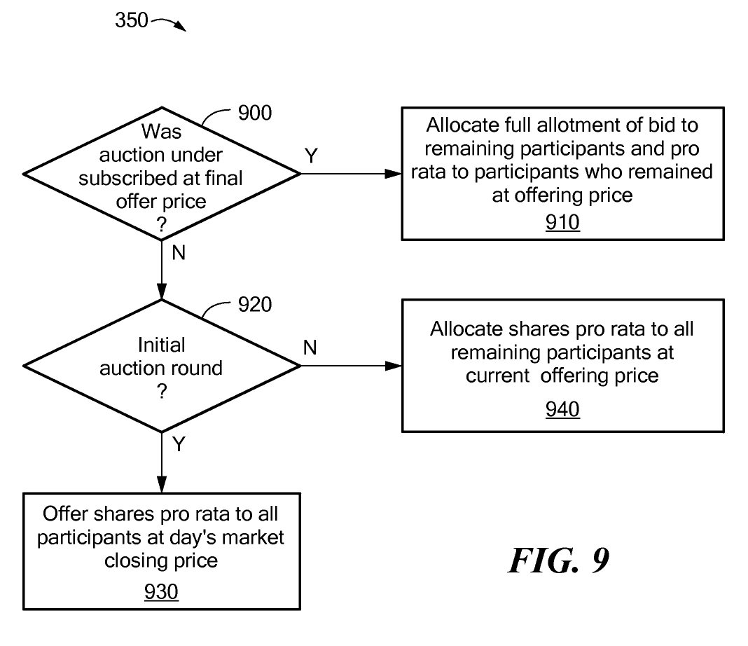

Referring to FIG. 9, shares are allocated according to a procedure 350 that awards shares cumulatively. First, a determination is made as to whether the auction was undersubscribed at the final offer price (step 900). If the auction was undersubscribed, those participants remaining in the auction get 100% of the shares for which they bid, while the participants who declined to move to the higher price receive a pro rata portion of the shares for which they bid at the offering price (step 910).

If the auction was not undersubscribed, and the auction concluded in the initial auction round (step 920), then the shares are offered pro rata to all participants at the day's close price on the security's principal exchange (step 930). If the auction did not conclude in the initial auction round, then the shares are allocated pro rata to all remaining participants at the current offering price (step 940).

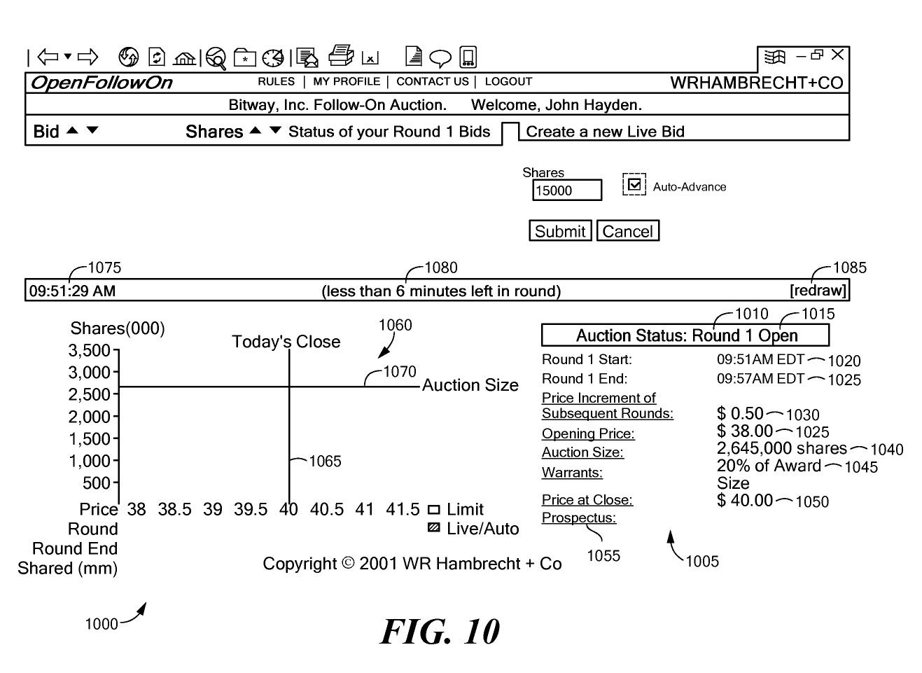

Referring to FIG. 10, one implementation of the system described above includes a graphical user interface (GUI) 1000 that displays key information to the participant. In one implementation, a web browser is used to navigate the information provided to the participant. The information provided through the web browser can be tailored to the individual participant. One method of tailoring allows the participant to select the location in the browser window at which specific information is displayed. Another method of tailoring allows the participant to select types of information to display from a master list of all information types.

In one implementation, an auction detail display 1005 is provided in the lower right quadrant of the browser window. The auction detail display includes the round number 1010 and status 1015. The round status can be either open or closed. The start time 1020 and stop time 1025 of the current round also are displayed. In addition, the price increment 1030 for subsequent rounds is provided so that participants can plan the minimum per-round increase of their bids. The opening price 1035 and auction size 1040 are provided for baseline information. Warrant information 1045 is provided if warrants are included in the auction. The close price 1050 for the security being auctioned on the public market also is provided. Finally, a link 1055 to the prospectus for the security being auctioned is provided.

The interface also provides a graphical representation 1060 of auction details. The graph is provided in the lower left quadrant of the browser window. In one implementation, a graph of the number of shares and the share price is provided. This graph also provides a reference mark 1065 (in the form of a vertical bar) that indicates the market close price for the shares and another reference mark 1070 (in the form of a horizontal bar) that indicates the auction size. During subsequent rounds, the graph displays volume and price information for each completed round of the auction.

The current time 1075 is presented in the border between the lower and upper quadrants of the browser window. A countdown timer 1080 also is provided. The countdown timer may change colors or font attributes (e.g. become bold) to indicate when a specific time threshold has been met (e.g. 30 seconds remaining in the round). This border also includes an application button 1085 that allows the participant to redraw the display and refresh the auction information.

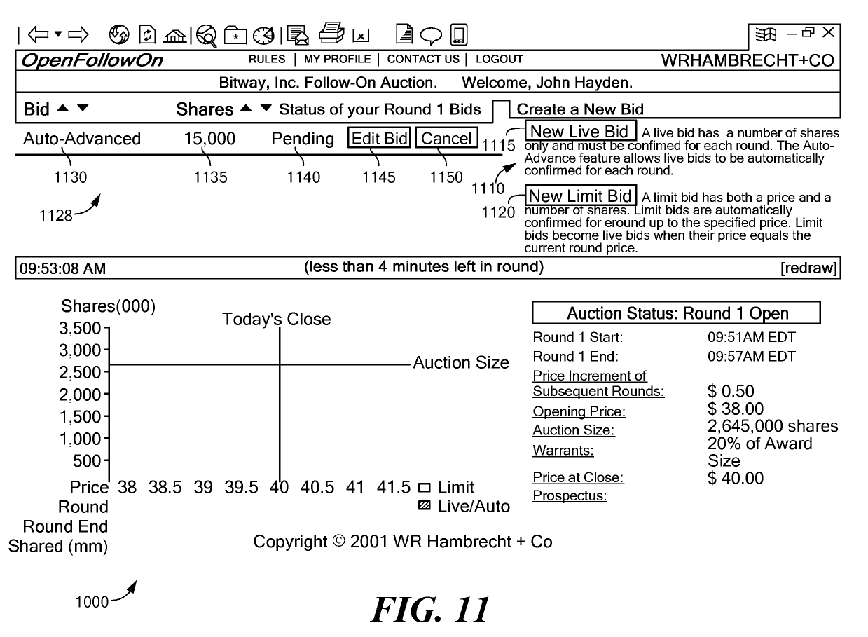

Referring also to FIG. 11, the graphical user interface 1000 allows the participant to interact with the auction. During the opening round, the participant can create new live or limit bids. The upper right quadrant of the browser window provides an interface 1110 for the participant to select new live or limit bids. A description of each bid type is provided for the participant. New bids are initiated by selecting the New Live Bid button 1115 or the New Limit Bid button 1120.

The upper left quadrant of the browser window provides the participant's bid summary information 1125. Information is provided about each bid's type 1130, number of shares 1135, and status 1140. The participant can use the Edit Bid button 1145 or Cancel button 1150 to modify a bid for any open or future rounds.

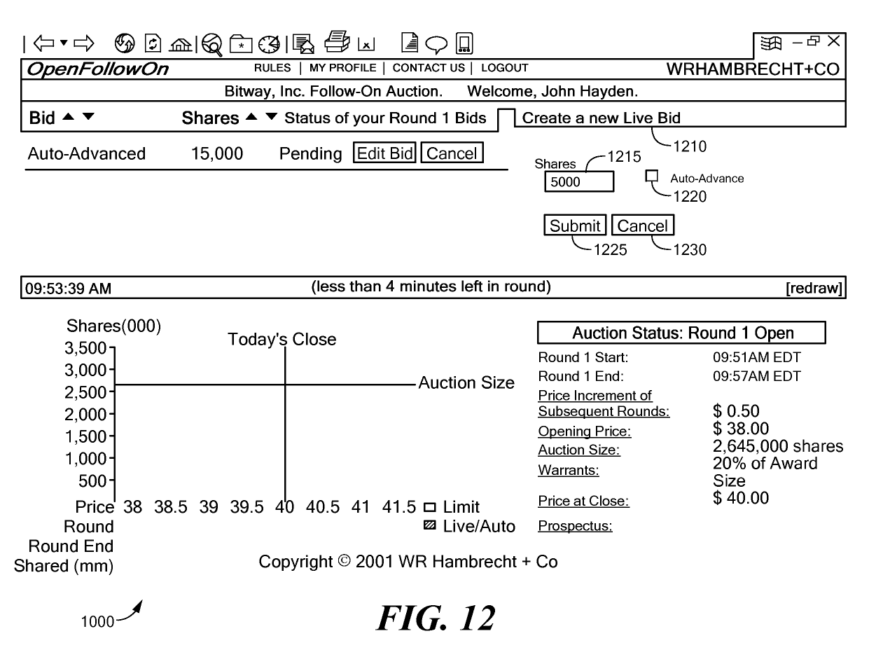

Referring also to FIG. 12, the graphical user interface 1000 changes as the participant makes selections. When the New Live Bid button 1115 is selected, the interface displays a notice 1210 informing the participant that a new live bid is being created. Input areas for the number of shares 1215 and auto-advance 1220 are presented to the participant. After supplying the number of shares desired for the bid and toggling the auto-advance selection, the participant may choose the Submit button 1225 to enter the new bid, or the Cancel button 1230 to exit the new bid process.

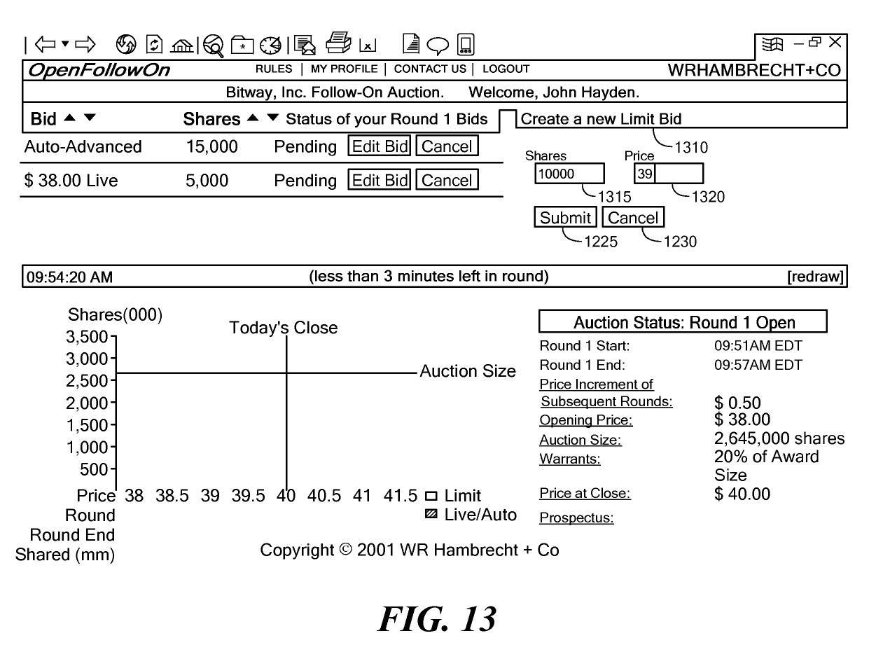

Referring also to FIG. 13, the GUI 1000 changes when the participant chooses the New Limit Bid button 1120. A notice 1310 is displayed informing the participant that a new limit bid is being created. The participant is presented with input areas for number of shares 1315 and limit price 1320. After supplying the number of shares desired for the bid and the maximum per-share price, the participant may choose the Submit button 1225 to enter the new bid, or the Cancel button 1230 to exit the new bid process.

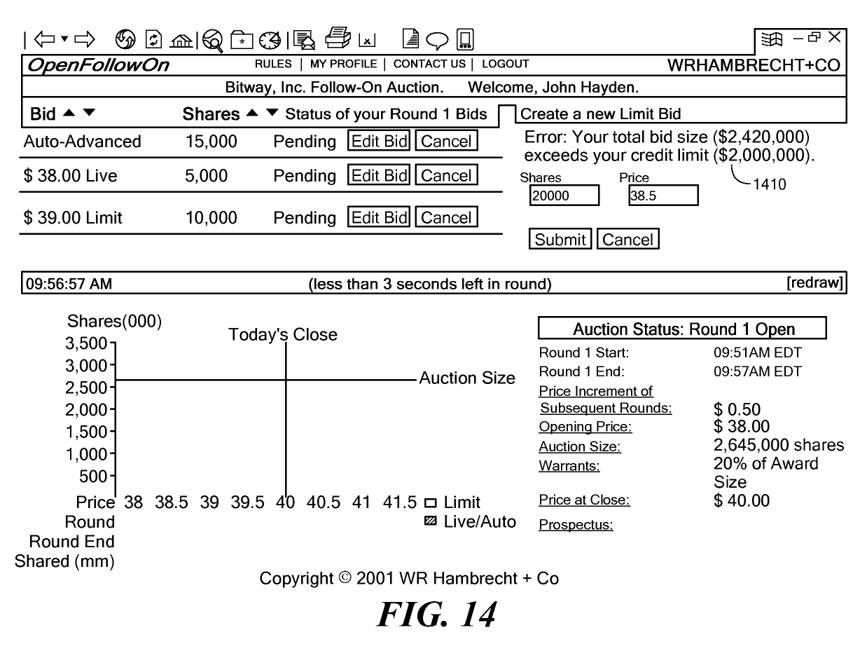

Referring also to FIG. 14, all bids are cumulatively awarded. As a result, the sum total of all bids must be less than or equal to the credit limit assigned to the participant. If a participant's total bid size exceeds the participant's credit limit, the new bid is not allowed and a notice 1410 is displayed indicating the total bid size and the credit limit. The participant is then given the opportunity to modify the bid to comply with the credit limitation.

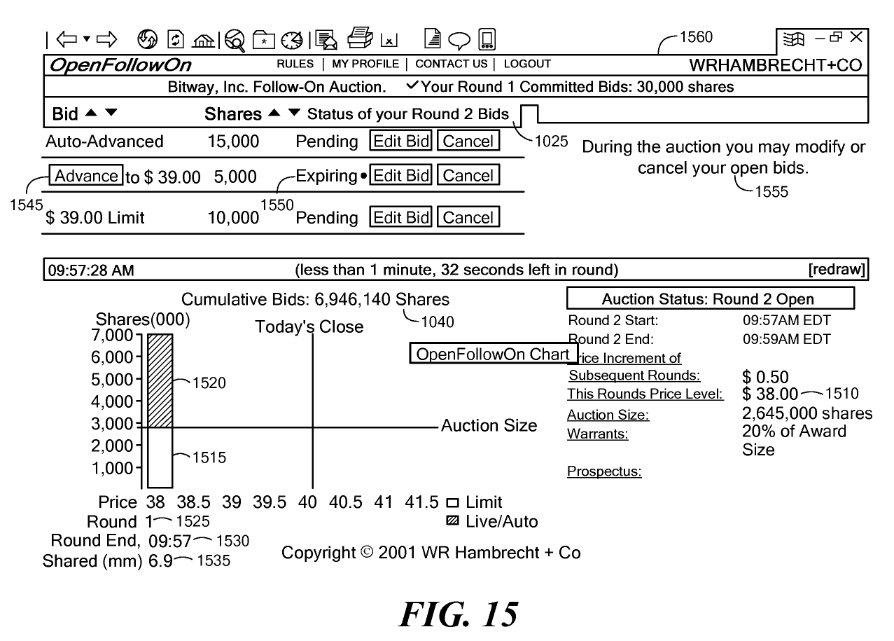

Referring also to FIG. 15, several portions of the GUI 1000 change after the conclusion of a round. For example, the opening price 1035 now indicates the price level of the current round 1510.

The graph 1060 is updated with the previous round's results. The graphical representation of the cumulative bid total is separated by bid type into limit bids 1515 and live bids 1520. Additionally, the round number 1525, round end time 1530, and cumulative share total 1535 are added to the graph. A graph title 1540 contains the total number of cumulative bids.

The bid listing also is updated. The bid summary 1025 is updated to reflect the current round number. An Advance button 1545 is presented for each live bid where the auto-advance feature is not selected. Additionally, the status of the bid 1550 is changed to Expiring to notify the participant that the bid will be lost if it is not advanced. A notice 1555 is displayed to remind the participant that open bids can be modified or cancelled during the auction. Bid modification or cancellation is only effective for auction rounds that have not yet closed.

Finally, a border 1560 near the top of the browser window is modified to display the cumulative total of shares that the participant committed to purchase as of the end of the previous round.

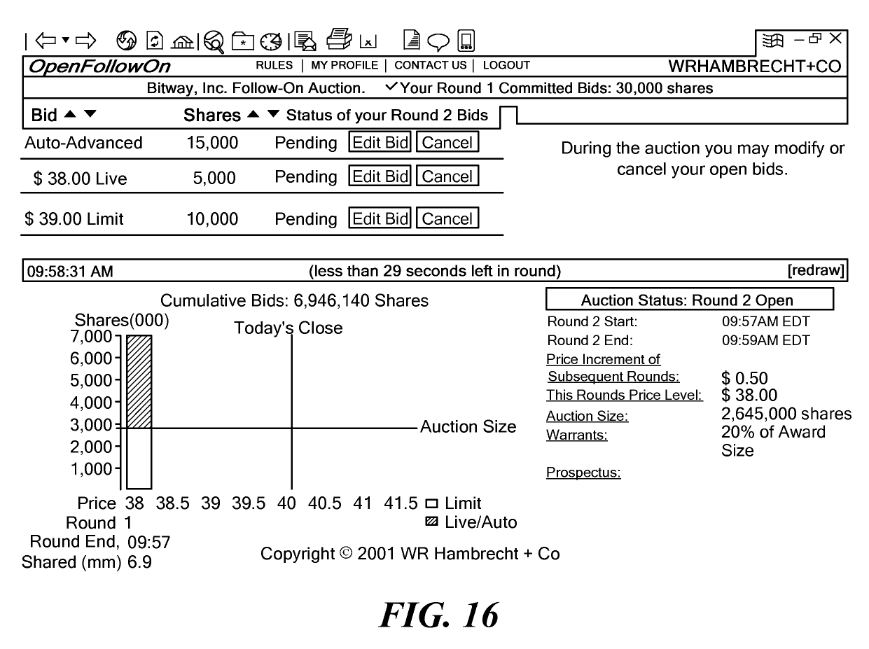

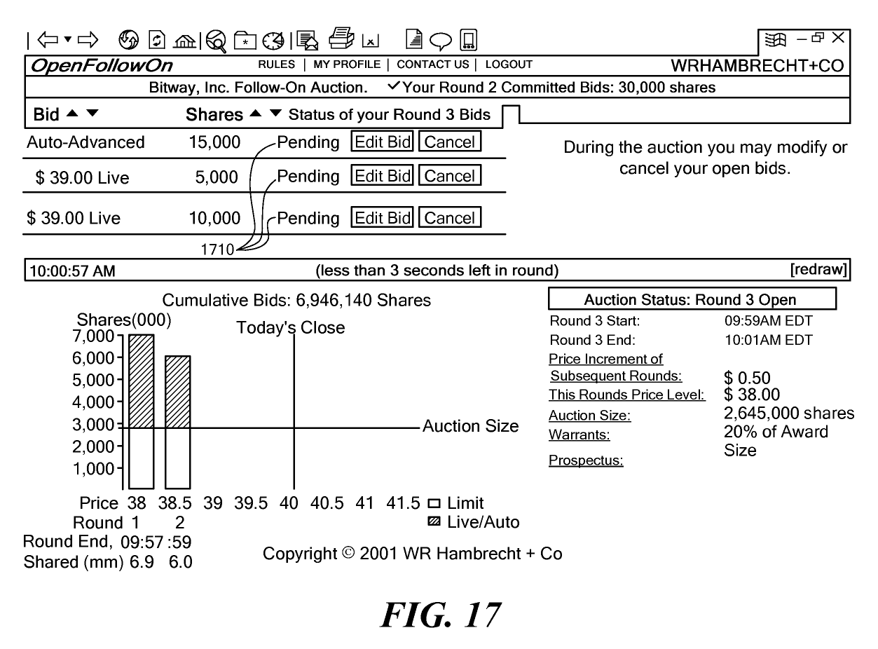

Referring also to FIG. 16, after the Advance button 1545 is selected, the bid price is updated to reflect the new bid price 1610 and the Advance button 1545 disappears. Referring also to FIG. 17, if all bids are set to auto-advance or meet or exceed the current offer price, their status remains pending 1710 and no participant action is required to continue to the next auction round.

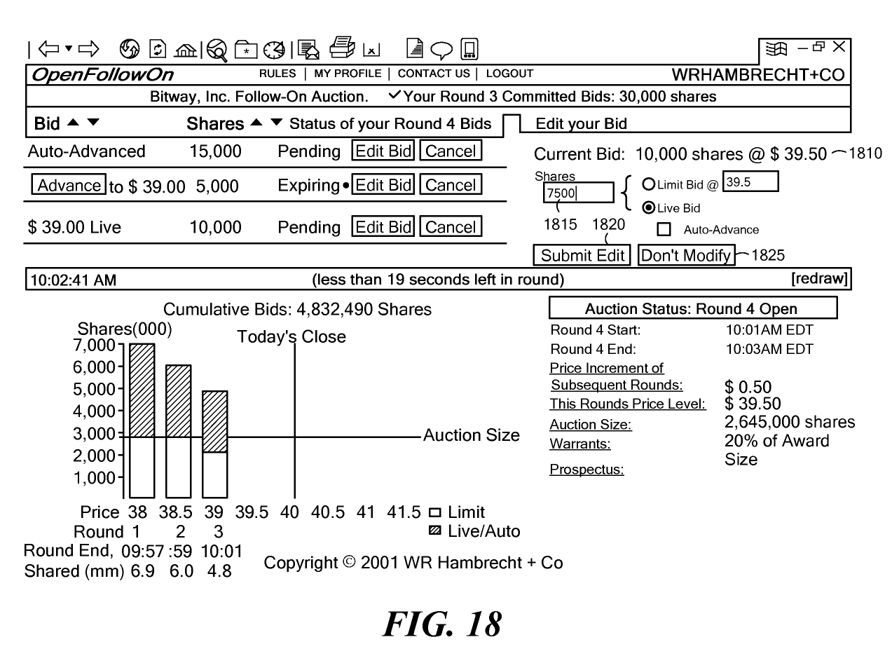

Referring to FIG. 18, bids can be modified during any running auction. When a participant chooses to edit a bid, the current details of the bid 1810 are displayed. The participant can use the share amount input box 1815 to reduce the number of shares in the bid. The participant must select the Submit Edit button 1820 to update the bid or use the Don't Modify button 1825 to retain the original bid information.

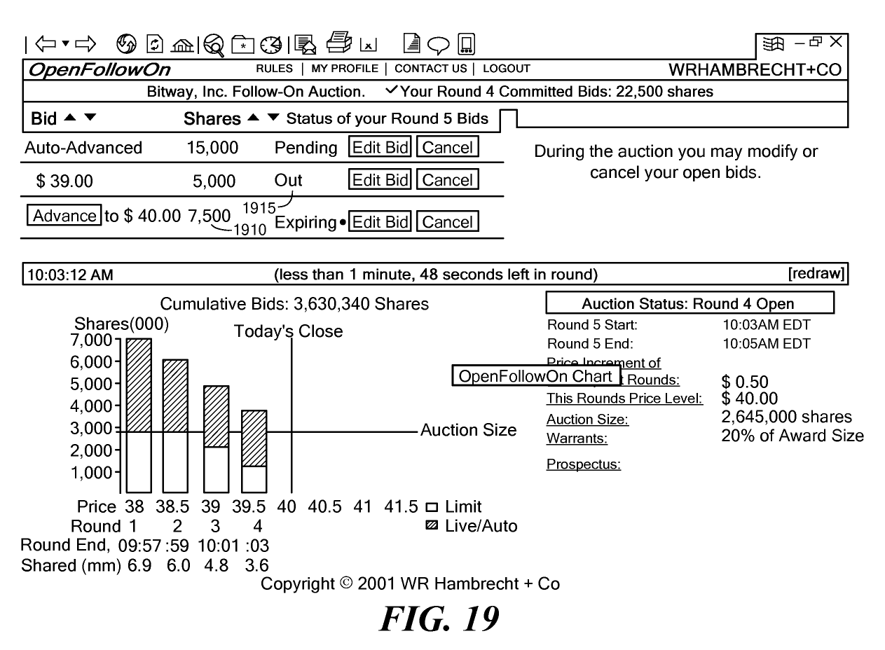

Referring to FIG. 19, after the bid modification is submitted, the number of shares 1910 is updated in the bid summary information display 1125. In addition, at the round's conclusion, a border 1560 is updated to reflect the new cumulative bid total. If the Advance button 1545 is not selected, the bid expires at the conclusion of the round. The bid status 1915 is changed from Expiring to Out. The Edit Bid button 1145 and Cancel button 1150 disappear. In one implementation, this bid can never be revived. However, if the auction is not fully subscribed at the next price increment, then the participant may still be entitled to a pro rata share of the offered securities.

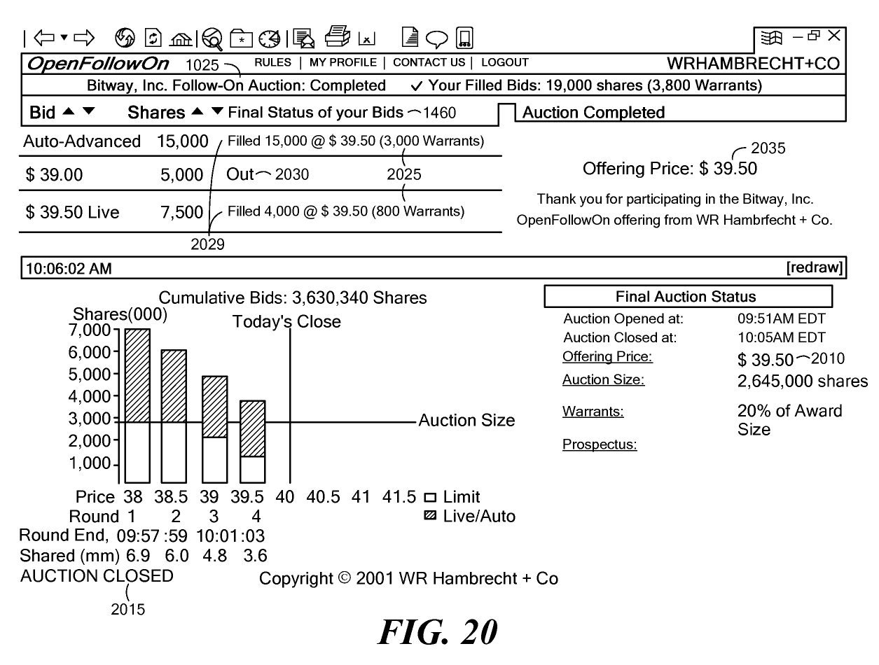

Referring also to FIG. 20, several portions of the GUI 1000 change after the conclusion of the auction. For example, the opening price 1035 now indicates the offering price as the auction closing price 2010. The graphical display 1060 is updated with the final round's results. Each round's total cumulative bids are listed. The auction status under the graph is changed to closed 2015. The bid listing also is updated. The bid summary 1025 is updated to reflect that the auction is completed. Additionally, the status 2020 of each remaining bid is changed to Filled and the quantity of shares and warrants awarded and the price per share are displayed 2025. Expired bids continue to be listed with a status 2030 of Out.

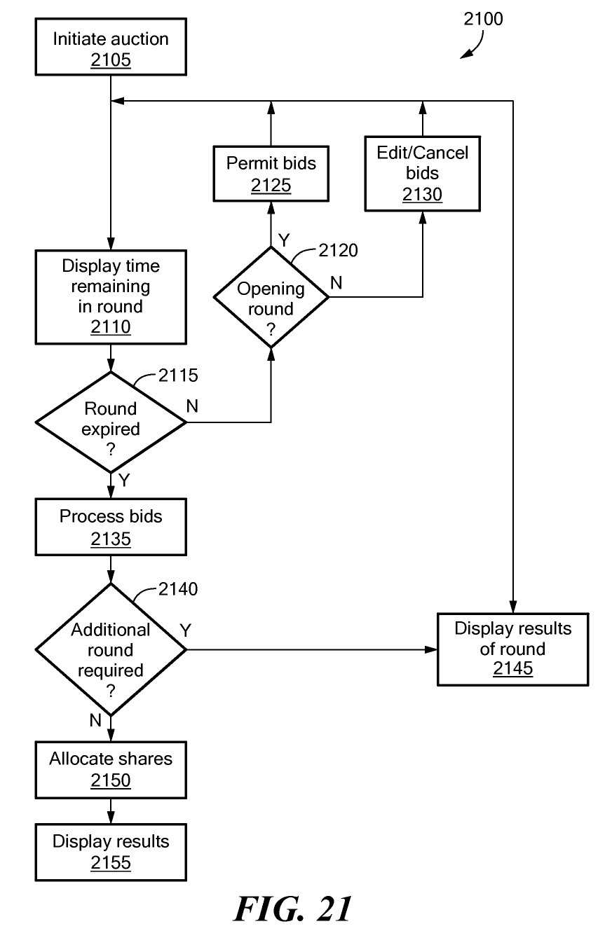

A border 1460 near the top of the browser window is modified to notify the participant that the auction is completed. The final offering price 2035 is displayed in the upper right quadrant. Finally, the border 1460 at the top of the browser window displays the total number of filled bids and warrants (if applicable) awarded to the participant. Referring to FIG. 21, another implementation auctions blocks of common stock from a secondary market according to a procedure 2100 that proceeds similarly to the auction procedure 225 described above for follow-on offerings. However, since offerors in this implementation are not necessarily the issuers of the common stock, some auction aspects are handled differently. For example, the participants and/or the offeror may remain anonymous.

Auction participants have access to additional information in this auction implementation. To facilitate buyer and seller participation, a maximum offering size is disclosed prior to the opening of the initial round. This implementation also uses pre-announced minimum transaction sizes when demand is insufficient to subscribe the entire block of common stock. The offering size and minimum transaction size information may be presented to auction participants in an auction detail display area or on a separate web page.

As in the procedure 225 described above with reference to FIG. 3, initiation of the auction (step 2105) is followed by display of the time remaining in the auction round (step 2110). A participant then is permitted to enter bids until the initial round expires, and to edit or cancel bids in subsequent rounds. In particular, after the time remaining has been displayed, a check is made as to whether the round has expired (step 2115) and, if not, a check is made as to whether the auction is in the opening round (step 2120). In the opening round, entry of bids is permitted (step 2125). In subsequent rounds, editing or canceling of bids is permitted (step 2130). Thereafter, the displayed time remaining in the round is updated (step 2110) and the process repeats until the round expires (step 2115). In one implementation, the opening round is 10 minutes long and subsequent rounds are 2 minutes long. Each auction may include multiple rounds.

Bids are processed at the conclusion of each round (step 2135). All bids that have not been withdrawn are considered. The auction continues through successive rounds until a rounds closes with the auction undersubscribed. An auction is undersubscribed when the demand for a security does not meet the minimum transaction size for the round. If an auction is not undersubscribed, then an additional round is required (step 2140). If an additional round is required (step 2140), then the new minimum transaction size, offering price, and round results are displayed (step 2145). If an additional round is not required (step 2140), the shares are allocated (step 2150). The shares are cleared at the highest price that completely satisfies a minimum transaction size.

After the shares are allocated, results are displayed (step 2155). As described above, the display may include the final clearing price and number of shares. Results may be communicated directly to a successful participant. Communication may be performed using e-mail. As described previously with respect to FIG. 4, a participant is permitted to enter live bids and limit bids according to a procedure 325.

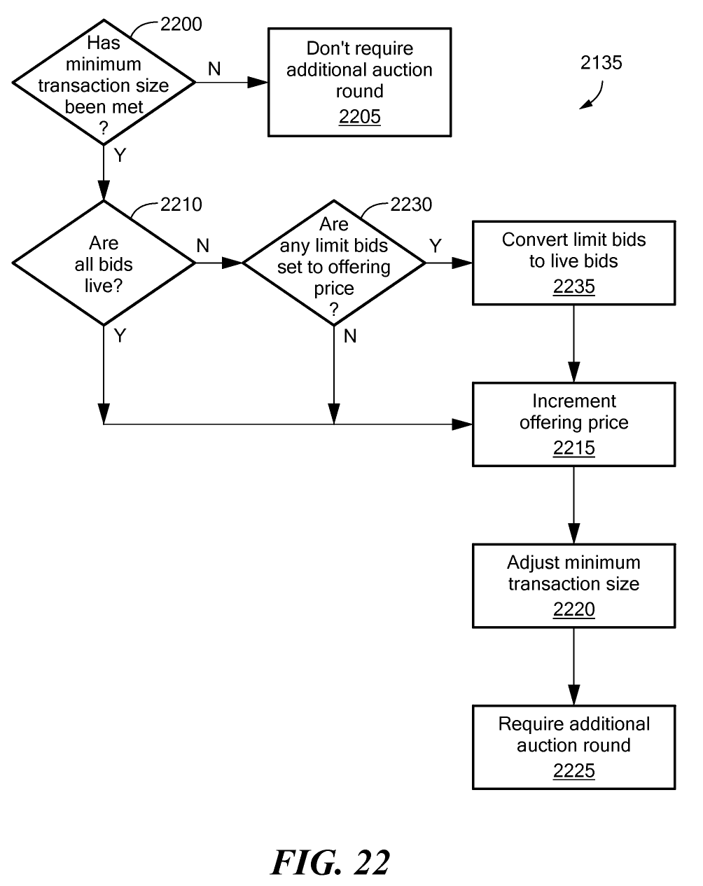

Referring to FIG. 22, bids are processed according to a procedure 2135 that is similar to the procedure 335 discussed above with respect to FIG. 8. First, a determination is made as to whether the minimum transaction size has been satisfied (step 2200). The minimum transaction size can change after each round. At the beginning of the auction, the minimum transaction size is set to its lowest level. The minimum transaction size then may increase up to 100% of the total block size as more rounds occur. For example, an offeror who has 1,000,000 shares to sell might set the initial minimum transaction size to 100,000 shares, and may increase the minimum transaction size by 100,000 shares each round until the minimum transaction size reaches 1,000,000 shares and equals the maximum offering size. If the minimum transaction size has not been satisfied, then the auction ends (i.e. no additional rounds are required) (step 2205) and shares are allocated according to a procedure 2150.

In one implementation (not shown), no allocation of shares is made if the minimum transaction size is not satisfied after the initial round. The offeror may choose to restart the auction at a lower price or a smaller minimum transaction size. In this implementation, all outstanding bids are cancelled, and participants are prompted to bid again.

If the minimum transaction size has been satisfied (step 2200), the bid types are reviewed. If all bids are live (step 2210), then the offering price is increased by a pre-announced auction-specific price increment (step 2215), the minimum transaction size is incremented according to the offeror's schedule for doing so (step 2220), and another auction round is required (step 2225). In this implementation, the pre-announced price increment may be a different amount each round.

If all bids are limit bids or there are a combination of limit bids and live bids (step 2210), the bid price of each limit bid is reviewed. If a limit bid price matches the offering price (step 2230), the limit bid is converted to a live bid for the next auction round (step 2235). Any limit bids with prices above the offering price are unaffected. Next, the offering price is increased by a pre-announced auction-specific price increment (step 2215), the minimum transaction size is adjusted (step 2220), and another auction round is required (step 2225).

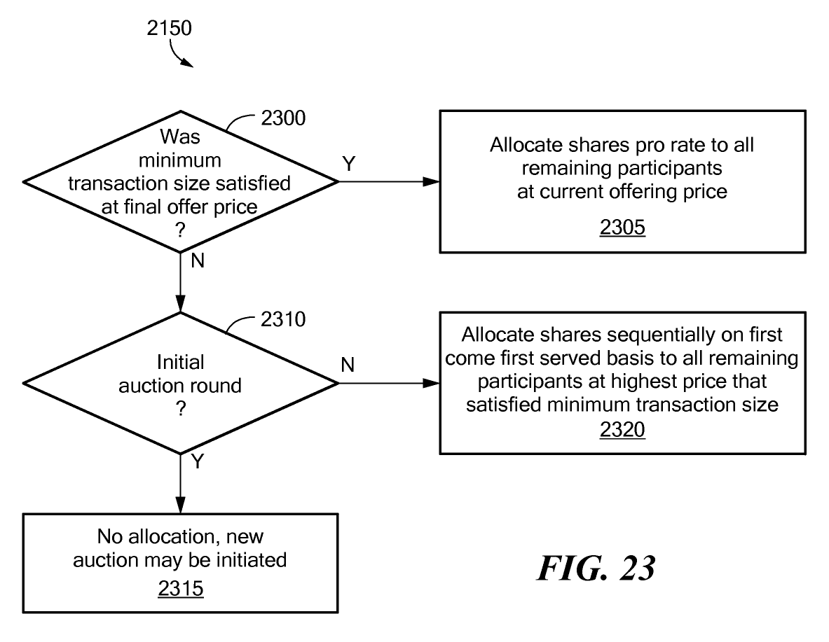

In another implementation, which is not shown, an auction also may end if the maximum offering size is fully subscribed and the offering price ascends to a price that is a certain level (e.g. 10%) over the day's closing price on the security's principal exchange. In this situation, each remaining bidder receives a pro rata allocation at that price. Referring to FIG. 23, shares are allocated according to a procedure 2150. In this implementation, if the minimum transaction size was satisfied at the final offer price (step 2300), then each remaining participant receives a pro rata portion of the number of shares for which the participant bid at the final offer price (step 2305). If the minimum transaction size was not satisfied (step 2300) and the auction concluded in the initial round (step 2310), then no allocation is made (step 2315). As described above, in one implementation (not shown) a new auction may be initiated at a lower price. If the minimum transaction size was not satisfied (step 2300) and the auction did not conclude in the initial round (step 2310), then shares are allocated sequentially on a first come, first served basis at the highest price for which demand satisfied the minimum transaction size (step 2320).

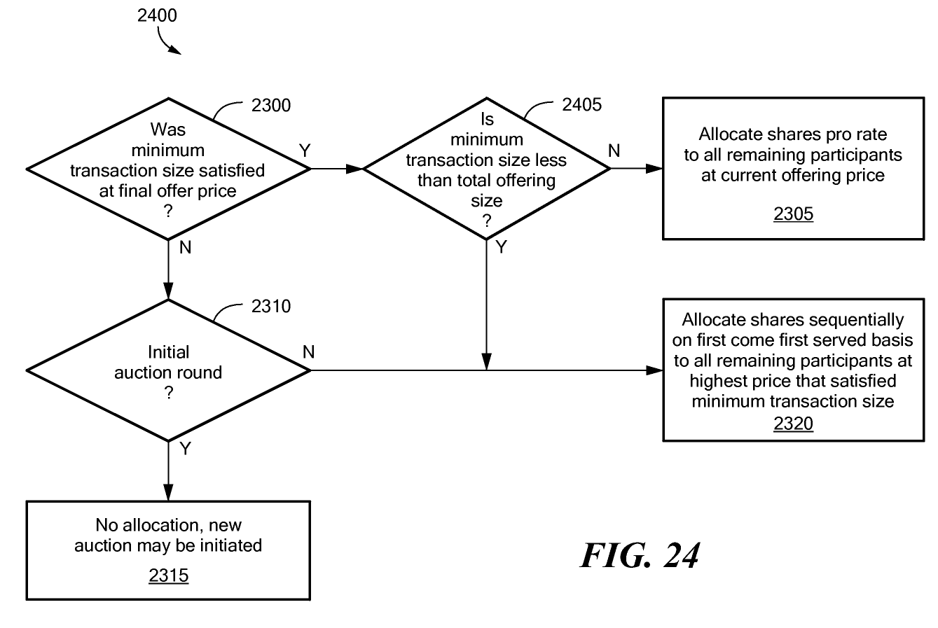

Referring to FIG. 24, shares may be allocated according to an alternative procedure 2400. This implementation is similar to the allocation procedure described above with reference to FIG. 23. However, this procedure considers the minimum transaction size and the total offering size. In particular, if the minimum transaction size was satisfied at the final offer price (step 2300) and the minimum transaction size was not less than the total offering size (step 2405), then each remaining participant receives a pro rata portion of the participant's bids at the final offer price (step 2305).

As described previously, if the minimum transaction size was satisfied at the final offer price (step 2300) and the minimum transaction size was less than the total offering size (step 2405), then shares are allocated sequentially on a first come, first served basis at the highest price for which demand satisfied the minimum transaction size (step 2320). Likewise, if the minimum transaction size was not satisfied (step 2300) and the auction did not conclude in the initial round (step 2310), then shares are allocated sequentially on a first come, first served basis at the highest price for which demand satisfied the minimum transaction size (step 2320).

If the minimum transaction size was not satisfied (step 2300) and the auction concluded in the initial round (step 2310), then no allocation is made (step 2315). As described above, in one implementation (not shown) a new auction may be initiated at a lower price.

As described above, the follow-on auction may be performed in multiple rounds. Of course, the preceding disclosure may also be relevant to single round auctions. Regardless, either type of auction may include a backstop bid. In one embodiment, bidders who bid above the backstop price may receive all (or some if the offering is oversubscribed) of their requested securities. The backstop bidder will then receive the remaining shares up to the amount they agreed to purchase. In most instances, the backstop bid will be for the entire number of securities offered. It should be understood that the backstop bid may be made by one or more bidders. That is, many bidders may combine to create a backstop bid having a single price. In other embodiments, multiple bidders may bid backstop bids having different prices.

In one embodiment, if there are no bidders above the backstop price, the backstop bidder will receive all of the securities it agreed to purchase at the backstop price. Of course, in most embodiments, the backstop bid will be for all of the securities offered. In some embodiments, the backstop bidder may receive compensation for agreeing to take on the risk associated with the bid. The amount of this compensation may be determined in any manner and may be, in some embodiments, a discount from the auction opening price for the securities. This approach may be implemented for issuers with liquid stocks and more easily quantifiable transaction risk and for smaller cap, less liquid names where the risks involved can be larger and more challenging to offset. One component of one embodiment may include ensuring that the pricing of the back-stop bids is fair to the issuer while sufficiently compensating the underwriter and/or capital partners for the assumed risk in buying the stock.

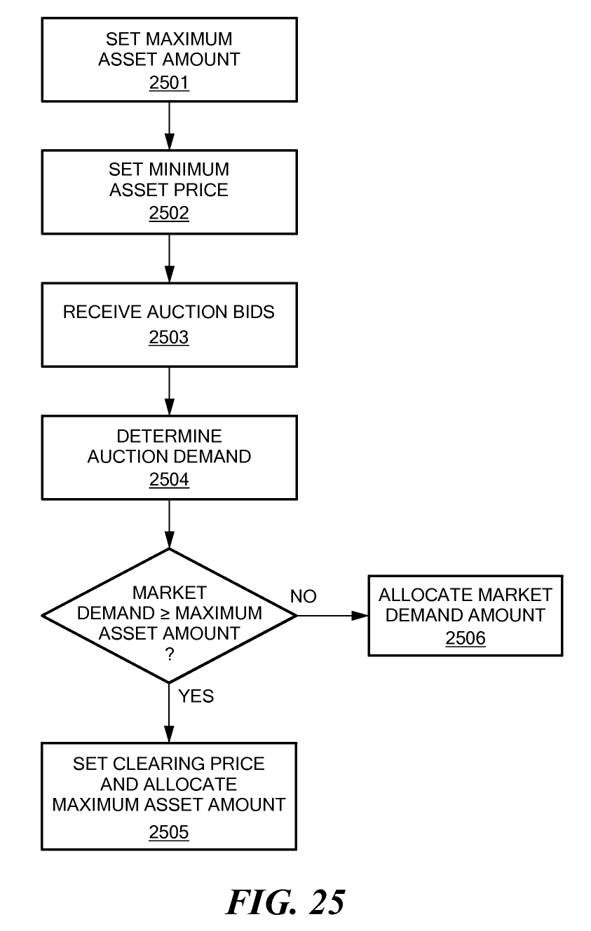

FIG. 25 is a flow chart of an offering allocation procedure in another embodiment of the present invention for auctioning exchange traded assets such as securities or commodities. Before the bidding starts, the seller establishes a maximum asset amount representing a greatest amount of the assets to be auctioned, step 2501, and a minimum asset price representing a minimum acceptable bid amount for a given amount of the assets, step 2502. In specific embodiments, the seller, at their discretion, may or may not disclose to the other auction participants their minimum acceptable price. During the bidding, bids are received for the assets, with each bid including a bid price and a corresponding bid amount of assets, step 2503. After the bidding ends, a market demand is determined that represents a total of all the bid amounts for the auction bids received during the auction bidding, step 2504. If the market demand is greater than or equal to the maximum asset amount, a clearing price is set that allocates the maximum asset amount of the exchange traded assets according to the auction bids at a final price between and including the clearing price and the minimum asset price (on a pro-rata basis), step 2506. Otherwise, if the market demand is less than the maximum asset amount, the market demand amount of exchange traded assets is allocated according to the auction bids at a final price equal to the minimum asset price, step 2507.

Embodiments of the invention may be implemented in any conventional computer programming language. For example, preferred embodiments may be implemented in a procedural programming language (e.g., “C”) or an object oriented programming language (e.g., “C++”, Python, or Java). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art will appreciate that such computer instructions can be written in a number of programming languages for use with many computer architectures or operating systems. And such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware.

Although various exemplary embodiments of the invention have been disclosed, it should be apparent to those skilled in the art that various changes and modifications can be made which will achieve some of the advantages of the invention without departing from the true scope of the invention.

What is claimed is:

1. A computer implemented method for auctioning exchange traded assets, the method comprising:
before commencing auction bidding, establishing:
i. a maximum asset amount representing a greatest amount of the exchange traded assets to be auctioned, and
ii. a minimum asset price representing a minimum acceptable bid amount for a given amount of the exchange traded assets;
during auction bidding, receiving a plurality of auction bids for the exchange traded assets, each auction bid including a bid price and a corresponding bid amount of assets;
after the auction bidding, determining a market demand representing a total of all the bid amounts for the auction bids received during the auction bidding; and
if the market demand is greater than or equal to the maximum asset amount, establishing a clearing price that allocates the maximum asset amount of the exchange traded assets according to the auction bids at a final price between and including the clearing price and the minimum asset price; or
else, if the market demand is less than the maximum asset amount, allocating the market demand amount of exchange traded assets according to the auction bids at a final price equal to the minimum asset price.

2. A method according to claim 1, wherein the exchange traded assets are exchange traded securities.

3. A method according to claim 1, wherein the exchange traded assets are exchange traded commodities.
